(19) United States
(12) Patent Application Publication
(10) Pub. No.: US 2026/0335961 A1
(43) Pub. Date: Oct. 29, 2026

(54) LOCATING FEATURE TOOL DESIGN

(71) Applicant: GM Global Technology Operations LLC, Detroit, MI (US)

(72) Inventors: Collins Angelo, Windsor (CA); Lu Huang, Troy, MI (US); Nathan Sigmund, Clinton Township, MI (US); Xiaosong Huang, Novi, MI (US); Rodrigo Franca Soares Campos, Rochester Hills, MI (US)

(21) Appl. No.: 19/188,458

(22) Filed: Apr. 24, 2025

(51) Int. Cl. B21D 28/26

(52) U.S. Cl. CPC B21D 28/265

(57) ABSTRACT

An apparatus for forming a locating boss within a sheet metal component includes a die assembly supporting a die having a die cavity formed therein, and a punch assembly supporting a punch, wherein the die assembly and the punch assembly are moveable relative to one another to bring the die assembly into operable engagement with the punch assembly with a sheet metal component positioned therebetween, the punch of the punch assembly adapted to extend into the die cavity to form a locating boss within the sheet metal component, the sheet metal component having a top surface that defines a first plane, and the die including features adapted to form a recessed channel within the top surface of the sheet metal component and extending along and immediately adjacent to the locating boss such that a fillet radius of the locating boss is positioned below the first plane.

### INTRODUCTION

The present invention relates generally to assemblies of two components, for example, vehicle components such as rechargeable energy storage systems (RESS’s) or battery systems, for vehicles.

A typical RESS assembly includes a cover secured thereto. The assembly process of this cover to the RESS assembly relies on manual operations to properly locate the cover to the RESS assembly, in particular to a tray of the RESS. The manual process is not compatible with assembly facilities with a high degree of automation. RESS assemblies that include a locating feature allow precise location of the components, however, formation of location features leaves a fillet radius at the point of formation that interferes with assembly of the cover to the RESS assembly.

Thus, while current systems and methods achieve their intended purpose, there is a need for an improved locating boss forming tool adapted to form a locating boss within a primary component, such as a tray of the RESS, that allows the locating boss to engage a secondary component, such as the cover of the RESS, for precise location of the primary component and the secondary component relative to one another and does not interfere with assembly of and engagement between the primary component and the secondary component.

### SUMMARY

According to several aspects of the present disclosure, and apparatus for forming a locating boss within a sheet metal component includes a die assembly adapted to support a die having a die cavity formed therein, and a punch assembly having a punch moveably supported therein, wherein, the die assembly and the punch assembly are operably positioned relative to one another and moveable relative to one another to bring the die assembly into operable engagement with the punch assembly with a sheet metal component positioned therebetween, the punch of the punch assembly adapted to extend into the die cavity to form a locating boss within the sheet metal component, the sheet metal component having a top surface that defines a first plane and a bottom surface that defines a second plane, the locating boss extending upward from the top surface, and the die including features adapted to form a recessed channel within the top surface of the sheet metal component and extending along and immediately adjacent to the locating boss such that a fillet radius of the locating boss is positioned below the first plane.

According to another aspect, the die includes a horizontal die surface and the punch assembly includes a mandrel extending around the punch and defining a horizontal mandrel surface, and, wherein, when the die assembly and the punch assembly are moved into operable engagement with one another with a sheet metal component therebetween, the horizontal die surface engages the top surface of the sheet metal component and the horizontal mandrel surface engages the bottom surface of the sheet metal component to secure the sheet metal component therebetween, and the punch is vertically moveable relative to the mandrel and is adapted to move upward into the die cavity, thereby forming the locating boss.

According to another aspect, the die includes an offset feature extending from the horizontal die surface along and immediately adjacent to the die cavity, wherein, when the die assembly and the punch assembly are moved into operable engagement with one another with the sheet metal component therebetween, the offset feature is adapted to form an offset portion within the sheet metal component extending along and immediately adjacent to the locating boss and extending below the second plane, the offset portion defining the recessed channel within the top surface of the sheet metal component.

According to another aspect, the horizontal mandrel surface of the punch assembly includes a relief channel formed therein, the relief channel adapted to allow formation of the offset portion within the sheet metal component without reducing a thickness of the sheet metal component, such that a nominal thickness of the sheet metal component and a thickness of the offset portion of the sheet metal component are uniform.

According to another aspect, the die includes an embossing feature extending from the horizontal die surface along and immediately adjacent to the die cavity, wherein, when the die assembly and the punch assembly are moved into operable engagement with one another with the sheet metal component therebetween, the embossing feature is adapted to form the recessed channel within the top surface of the sheet metal component.

According to another aspect, the embossing feature is adapted to compress the sheet metal component between the embossing feature and the horizontal mandrel surface of the punch assembly, and reduce a thickness of the sheet metal component to define the recessed channel, wherein, a portion of the sheet metal component that defines the recessed channel within the top surface of the sheet metal component has a thickness that is less than a nominal thickness of the sheet metal component, and no portion of the bottom surface of the sheet metal component extends below the second plane.

According to another aspect, the die cavity includes a tapered region adapted to form a tapered profile tip within the locating boss.

According to another aspect, an inner dimension of the die cavity and an outer dimension of the punch define a clearance dimension that is less than a nominal thickness of the sheet metal component.

According to another aspect, when the die assembly and the punch assembly are moved into operable engagement with one another with the sheet metal component therebetween and the punch is vertically moved upward into the die cavity, the die cavity and the punch are adapted to iron side walls of the resulting locating boss.

According to another aspect, the apparatus is adapted to form a locating boss including one of, one of a continuous cylindrical or conical wall, discontinuous flanges, or a combination of a continuous wall and discontinuous flanges.

According to another aspect, the die assembly is adapted to support one of a plurality of different dies having die cavities of varying shapes and sizes, and the punch assembly is adapted to support one of a plurality of different punches having shapes and sizes corresponding to the plurality of dies.

According to another aspect, the die includes a plurality of individual die inserts, each die insert being selectively moveable horizontally wherein the shape and size of the die cavity is selectively adjustable, and the punch includes a plurality of individual punch inserts, each punch insert being selectively moveable horizontally wherein the shape and size of the punch is selectively adjustable.

According to several aspects of the present disclosure, an apparatus for forming a locating boss within a sheet metal component of a rechargeable energy storage system (RESS), includes a die assembly adapted to support a die having a horizontal die surface and a die cavity formed therein, and a punch assembly having a punch moveably supported therein and a mandrel extending around the punch and defining a horizontal mandrel surface, wherein, the die assembly and the punch assembly are operably positioned relative to one another and moveable relative to one another to bring the die assembly into operable engagement with the punch assembly with the sheet metal component positioned therebetween, wherein the sheet metal component has a top surface that defines a first plane and a bottom surface that defines a second plane, the locating boss extending upward from the top surface, the horizontal die surface adapted to engage the top surface of the primary component and the horizontal mandrel surface adapted to engage the bottom surface of the sheet metal component to secure the sheet metal component therebetween, the punch is vertically moveable relative to the mandrel and is adapted to move upward into the die cavity, thereby forming the locating boss, and the die including features adapted to form a recessed channel within the top surface of the sheet metal component and extending along and immediately adjacent to the locating boss such that a fillet radius of the locating boss is positioned below the first plane.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a schematic side sectional view of an apparatus for forming a locating boss within a sheet metal component according to an exemplary embodiment of the present disclosure;

FIG. 1B is a schematic side sectional view similar to FIG. 1A before the locating boss has been formed within the sheet metal component;

FIG. 1C is a schematic side sectional view similar to FIG. 1A wherein a die assembly and a punch assembly have been moved into engagement with the sheet metal component therebetween;

FIG. 2 is a perspective view of a secondary component being assembled to a sheet metal component according to an exemplary embodiment;

FIG. 3 is a sectional view of a rechargeable energy storage system including a tray having a locating boss formed in accordance with the present disclosure;

FIG. 4 is an enlarged portion of FIG. 3, as indicated by the circled portion of FIG. 3 labelled “FIG. 4”;

FIG. 5A is an enlarged portion of FIG. 4, as indicated by the circled portion of FIG. 4 labelled “FIG. 5”;

FIG. 5B is an enlarged portion of FIG. 5A, as indicated by the circled portion of FIG. 5A labelled “FIG. 5B”;

FIG. 6 is a view similar to FIG. 2, wherein the locating boss and locating opening have a generally square shape;

FIG. 7A is a bottom view of a die assembly having a circular die cavity therein with an offset/embossing feature extending from a horizontal die surface;

FIG. 7B is a bottom view similar to FIG. 7A wherein the die cavity is generally square shaped and the offset/embossing feature includes four individual offset/embossing features;

FIG. 8 is a view similar to FIG. 5A according to another embodiment of the present disclosure;

FIG. 9 is a view similar to FIG. 1C, wherein the die include an embossing feature extending downward from the horizontal die surface and the mandrel does not include a relief channel;

FIG. 10A is a sectional view similar to FIG. 4 wherein the locating boss includes tapered profile tips;

FIG. 10B is a side sectional view of a die assembly wherein the die is adapted to form the tapered profile tips shown in FIG. 10A;

FIG. 11A is a top view of a sheet metal component wherein a pattern defining a plurality of discontinuous flanges are cut within the sheet metal component prior to forming of the locating boss with the apparatus;

FIG. 11B is a top view of a sheet metal component similar to FIG. 11A wherein a different pattern is cut within he sheet metal component;

FIG. 12 is a side sectional view of the apparatus wherein the die assembly is adapted support a module die and the punch assembly is adapted to support a modular punch;

FIG. 13A is a sectional view taken along line labelled “FIG. 13A – FIG. 13A” in FIG. 12, wherein the apparatus is using a first modular die and a first modular punch;

FIG. 13B is a sectional view similar to FIG. 13A wherein the apparatus is using a second modular die and a second modular punch;

FIG. 13C is a sectional view similar to FIG. 13A wherein the apparatus is using a third modular die and a third modular punch;

FIG. 14 is a side sectional view of an apparatus equipped with a die comprising a plurality of die inserts and a punch comprising a plurality of punch inserts;

FIG. 15 is a sectional view taken along the line labelled “FIG. 15 – FIG. 15” in FIG. 14, wherein the plurality of die inserts are selectively positioned in a first arrangement;

FIG. 16 is a sectional view taken along the line labelled “FIG. 16 – FIG. 16” in FIG. 14, wherein the plurality of punch inserts are selectively positioned in a first arrangement;

FIG. 17 is a sectional view similar to FIG. 15 wherein the plurality of die inserts are selectively positioned in a second arrangement;

FIG. 18 is a sectional view similar to FIG. 16 wherein the plurality of punch inserts are selectively positioned in a second arrangement; and

FIG. 19 is a schematic flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

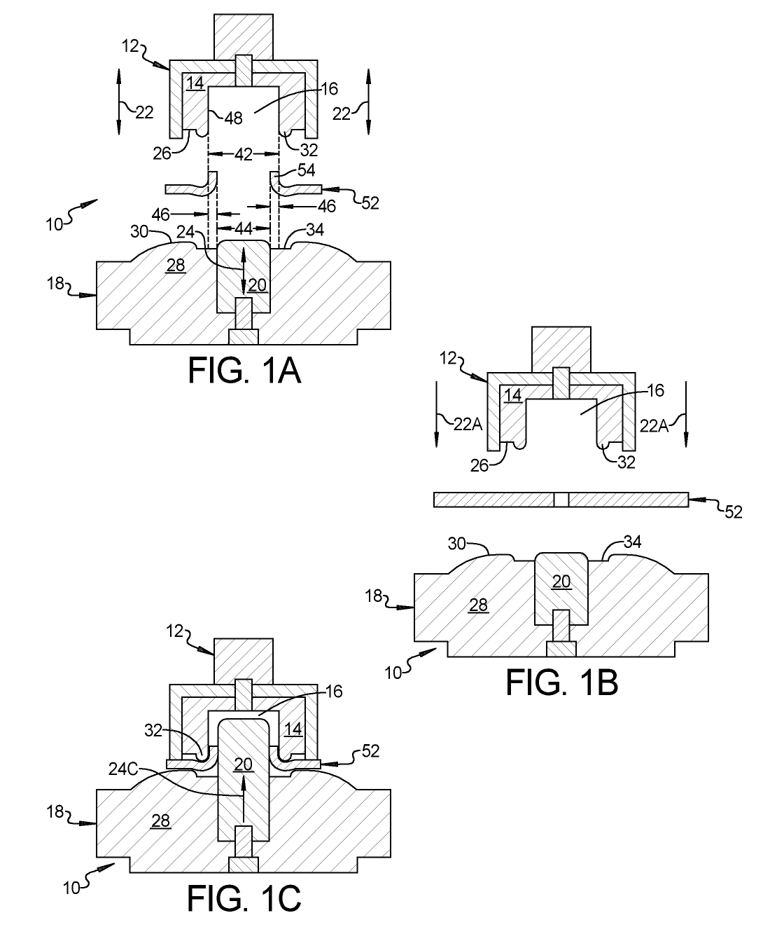

Referring to FIG. 1A, an apparatus 10 for forming a locating boss 54 within a sheet metal component 52, includes a die assembly 12 adapted to support a die 14 having a die cavity 16 formed therein, and a punch assembly 18 having a punch 20 moveably supported therein. The die assembly 12 and the punch assembly 18 are operably positioned relative to one another and moveable relative to one another, as indicated by arrows 22 to bring the die assembly 12 into operable engagement with the punch assembly 18 with a sheet metal component 52 positioned therebetween. Referring to FIG. 1B, when the sheet metal component 52 is placed between the die assembly and the punch assembly, the die assembly 12 and the punch assembly 20 move toward one another, as indicated by arrows 22B, until, referring to FIG. 1C, the die assembly 12 and the punch assembly 20 come to a final engaged position and the locating boss 54 has been formed. While described generically, the arrows 22, 22A in FIGS. 1A and. 1B illustrate the die assembly 12 moving up and down relative to a fixed punch assembly 18. It should be understood by those skilled in the art that either one or both of the die assembly 12 or the punch assembly 18 may be vertically moveable up and down to facilitate movement of the die assembly 12 and the punch assembly 18 relative to one another.

The punch 20 of the punch assembly 18 is adapted to move up and down, relative to and independently of the punch assembly 18, as indicated by arrow 24. Referring again to FIG. 1C, once the die assembly 12 and the punch assembly 18 have moved to the engaged positions, the punch 20, moves up, as indicated by arrow 24C to push upward through the sheet metal component 52, as is known in the art of extrusion die punch processes, to form the locating boss 54 within the sheet metal component 52.

The die 14 includes a horizontal die surface 26 and the punch assembly 18 includes a mandrel 28 extending around the punch 20 and defining a horizontal mandrel surface 30. When the die assembly 12 and the punch assembly 18 are moved into operable engagement with one another, as shown in FIG. 1C, the horizontal die surface 26 engages a top surface 68 of the sheet metal component 52 and the horizontal mandrel surface 30 engages the bottom surface 72 of the sheet metal component 52 to secure the sheet metal component 52 therebetween, and the punch 20 moves upward, as indicated by arrow 2C, relative to the mandrel 28 and upward into the die cavity 16, thereby forming the locating boss 54, wherein the locating boss 54 extends upward from the top surface 68.

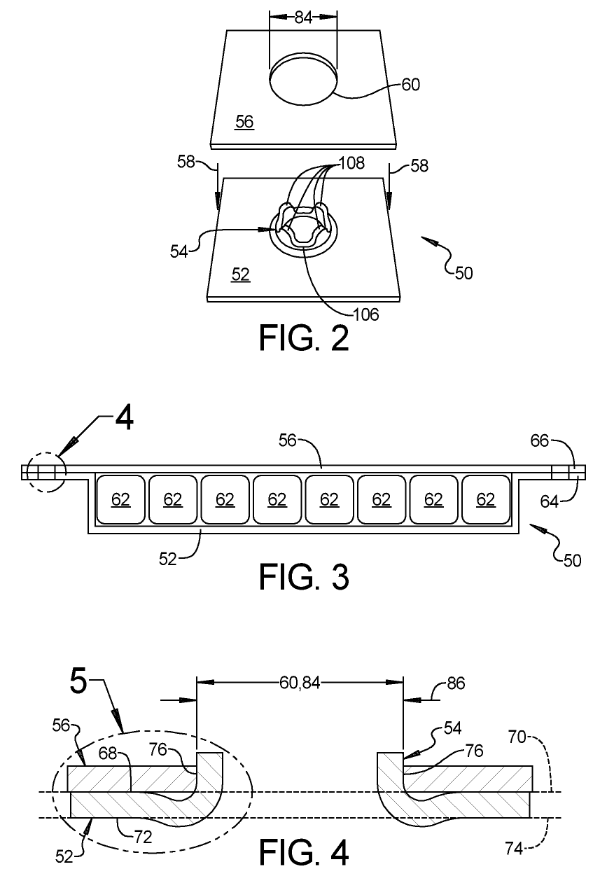

The die 14 includes features 32, 36 adapted to form a recessed channel 78 within the top surface 68 of the sheet metal component 52 extending along and immediately adjacent to the locating boss 54 such that a fillet radius 80 of the locating boss 54 is positioned below a first plane 70 defined by the top surface 68. Referring to FIG. 2, a sheet metal component assembly 50 is shown wherein a primary component (sheet metal component 52) includes a locating boss 54 formed therein and a secondary component 56 is placed onto the primary component 52, as indicated by arrows 58, wherein the locating boss 54 engages a locating opening 60 within the secondary component 56 to position the primary component 52 and the secondary component 56 relative to one another.

Referring to FIG. 3, in an exemplary embodiment the sheet metal component assembly 50 is a rechargeable energy storage system (RESS) 50. FIG. 3 is a cross-sectional view of an exemplary embodiment of a RESS assembly 50. The RESS assembly 50 includes a primary component (sheet metal component 52) that defines a tray with a plurality of cells 62 disposed therein. The secondary component 56 defines a cover to enclose the RESS assembly 50. The primary component (sheet metal component 52) includes a tray flange 64 that in some embodiments defines an outer perimeter. Similarly, the secondary component 56 includes a cover flange 66 that in some embodiments defines an outer perimeter of the secondary component 56. In some embodiments, the primary component (sheet metal component 52) and the secondary component 56 are formed from a sheet metal material. One skilled in the art, however, will readily appreciate that the primary component (sheet metal component 52) and/or the secondary component 56 may be formed from another material such as a plastic or fiber reinforced composite material. While this arrangement is illustrated and described herein, one skilled in the art will readily appreciate that in some embodiments, the configuration may be substantially reversed, wherein the primary component (sheet metal component 52) defines the cover of the RESS 50 and the secondary component 56 defines the tray of the RESS 50. Further, it should be understood that the sheet metal component 52 as claimed herein or the primary component of the sheet metal assembly or RESS 50, is the sheet metal component 52 including the locating boss 54 formed by the apparatus 10 described herein.

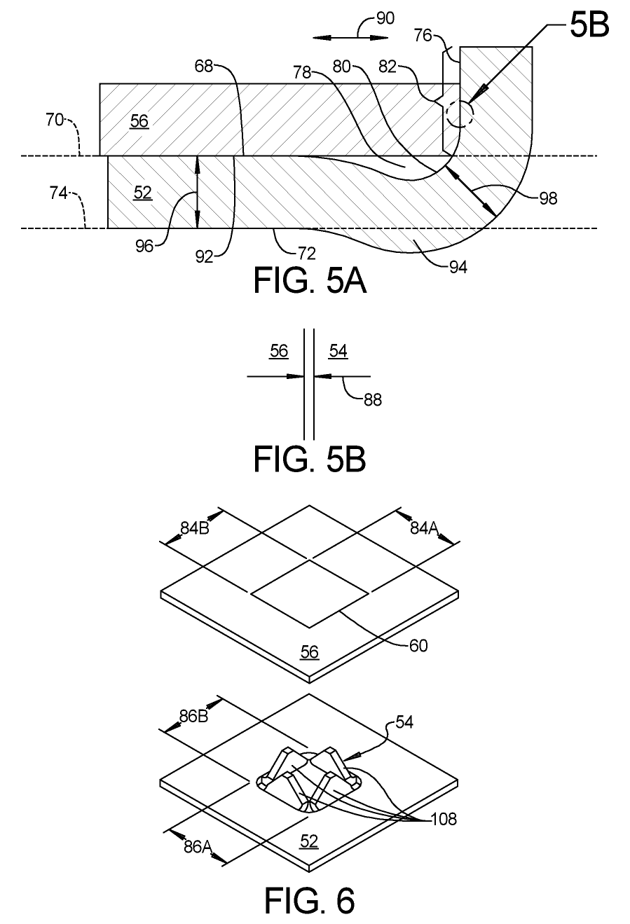

Referring to FIGS. 4 and 5A, the sheet metal component 52 includes the top surface 68 that defines the first plane 70 and the bottom surface 72 that defines a second plane 74. The locating boss 54 is integrally formed with the sheet metal component 52 and extends upward from the top surface 68. The locating boss 54 further includes an outer side wall 76. The top surface 68 of the sheet metal component 52 includes a recessed channel 78 extending along and immediately adjacent to the locating boss 54 such that the fillet radius 80 of the locating boss 54 is positioned below the first plane 70 and a portion of the outer side wall 76 that extends above the first plane 70, as indicated at 82, is vertical relative to the first plane 70, which is horizontal.

Referring again to FIG. 2, the locating opening 60 within the secondary component 56 has an inner dimension 84 and the locating boss 54 has an outer dimension 86 adapted to precisely position the secondary component 56 relative to the sheet metal component 52. As shown, in FIG. 2, in an exemplary embodiment, the general shape of the locating opening 60 and the locating boss 54 is circular, wherein the inner dimension 84 of the locating opening 60 is an inner diameter and the outer dimension 86 of the locating boss is an outer diameter. As shown, in FIG. 6, in another exemplary embodiment, the general shape of the locating opening 60 and the locating boss 54 is square (four-sided), wherein the inner dimension 84 of the locating opening 60 includes an inner dimension 84A along an X-axis and an inner dimension 84B along a Y-axis, and the outer dimension 86 of the locating boss includes an outer dimension 86A along the X-axis and an outer dimension 86B along the Y-axis. It should be understood by those skilled in the art, that the general shape of the locating boss 54 and the corresponding shape of the locating opening 60 may be circular, oval, square, or any other polygonal shape.

The design and formation of the locating boss 54 is further described in related United States Patent Application No. 18/800,395, entitled “SELF-LOCATION FEATURES FOR COMPONENT ASSEMBLY”, filed on Aug. 12, 2024, the entire contents of which is hereby incorporated by reference.

To facilitate precise location of the secondary component 56 relative to the sheet metal component 52, the tolerance between the inner dimension 84 of the locating opening 60 and the outer dimension 86 of the locating boss 54 must be close. In an exemplary embodiment, the inner dimension 84 of the locating opening 60 is slightly larger than the outer dimension 86 of the locating boss 54, wherein when the secondary component 56 is assembled to the sheet metal component 52, referring to FIG. 5B, there will be clearance 88 between the locating opening 60 and the outer side wall 76, allowing very little movement of the secondary component 56, as indicated by arrow 90, relative to the sheet metal component 52. The difference between the inner dimension 84 of the locating opening 60 and the outer dimension 86 of the locating boss 54 is carefully calibrated to maintain positional tolerances between the sheet metal component 52 and the secondary component 56.

In another exemplary embodiment, the inner dimension 84 of the locating opening 60 is slightly smaller than the outer dimension 86 of the locating boss 54, wherein when the secondary component 56 is assembled to the sheet metal component 52, there is an interference fit between the outer side wall 76 of the locating boss 54 and the locating opening 60, wherein no movement will be allowed between the secondary component 56 and the sheet metal component 52.

Because the portion of the outer side wall 76 that extends above the first plane 70, as indicated at 82, is vertical relative to the first plane 70, and the fillet radius 80 of the locating boss 54 is positioned below the first plane 70, the secondary component 56 is able to be positioned directly onto the sheet metal component 52, wherein the top surface 68 of the sheet metal component 52 is in direct contact with an adjacent bottom surface 92 of the secondary component 56. Too much interference or the presence of the fillet radius 80 of the locating boss 54 being positioned above the first plane 70 would result in the secondary component 56 being suspended above the top surface 68 of the sheet metal component 52.

Referring again to FIG. 5A, in an exemplary embodiment, the sheet metal component 52 includes an offset portion 94 extending along and immediately adjacent to the locating boss 54 and extending below the second plane 74. The offset portion 94 defines the recessed channel 78 within the top surface 68 of the sheet metal component 52. A nominal thickness 96 of the sheet metal component 52 and a thickness 98 of the offset portion 94 are uniform.

Referring again to FIG. 1A, in an exemplary embodiment, the die 14 includes an offset feature 32 extending from the horizontal die surface 26 along and immediately adjacent to the die cavity 16, wherein, when the die assembly 12 and the punch assembly 18 are moved into operable engagement with one another with the sheet metal component 52 therebetween, as shown in FIG. 1C, the offset feature 32 is adapted to form the offset portion 94 within the sheet metal component 52 extending along and immediately adjacent to the locating boss 54 and extending below the second plane 74. The offset portion 94 defines the recessed channel 78 within the top surface 68 of the sheet metal component 52.

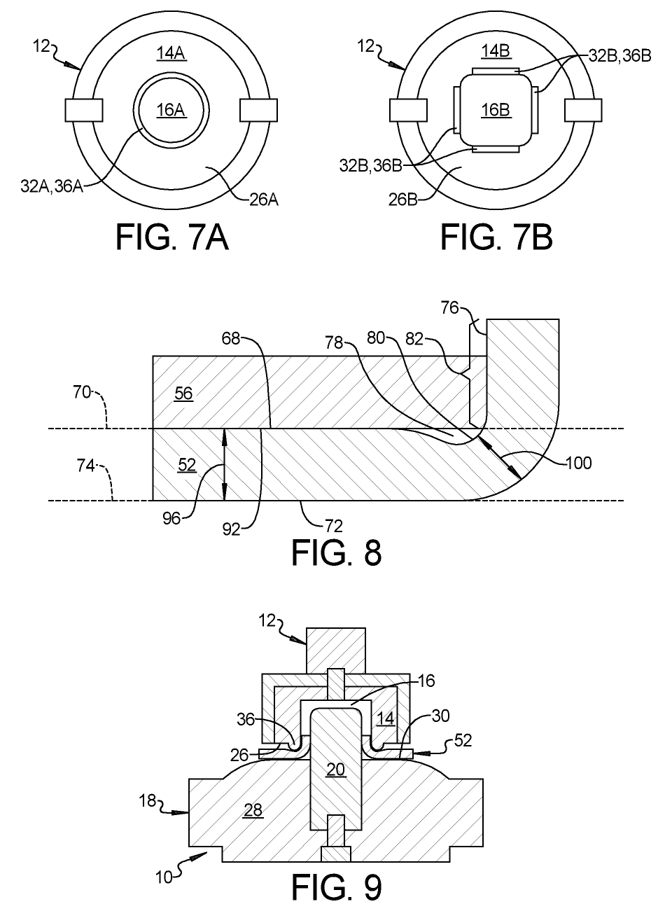

Referring to FIG. 7A, a bottom view of a die 14A corresponding to the circular locating boss 54 shown in FIG. 2 is shown. The horizontal die surface 26A of the die 14A includes a continuous offset feature 32A extending around the die cavity 16A. Referring to FIG. 7B, a bottom view of a die 14B corresponding to the square locating boss 54 shown in FIG. 6 is shown. The horizontal die surface 26B of the die 14B includes four individual offset features 32B positioned adjacent to the die cavity 16B, each one adapted to form the offset portion 94 adjacent one of the four discontinuous flanges 108 of the locating boss 54.

Referring again to FIGS. 1A, 1B and 1C, in another exemplary embodiment, the horizontal mandrel surface 30 of the punch assembly 18 includes a relief channel 34 formed therein. The relief channel 34 is adapted to allow formation of the offset portion 94 within the sheet metal component 52 without reducing the nominal thickness 96 of the sheet metal component 52, such that the nominal thickness 96 of the sheet metal component 52 and the thickness 98 of the offset portion 94 are uniform.

Dimensional characteristics of the offset feature 32 and the relief channel 34 are dependent upon required dimensional characteristics of the offset portion 94 and the recessed channel 78. The purpose of the recessed channel 78 and the offset portion 94 is to push the fillet radius 80 below the first plane 70. The size of the fillet radius 80 is dependent on the material type and material thickness. A thicker sheet metal component 52 will have a larger fillet radius 80, and thus, require a larger (deeper, wider) recessed channel 78 to ensure the fillet radius 80 is below the first plane 70.

Referring to FIG. 8, in another exemplary embodiment, no portion of the bottom surface 72 of the sheet metal component 52 extends below the second plane 74, and a portion of the sheet metal component 52 that defines the recessed channel 78 within the top surface 68 of the primary component 52 has a thickness 100 that is less than the nominal thickness 96 of the sheet metal component 52.

Referring to FIG. 9, in an exemplary embodiment the die 14 includes an embossing feature 36 extending from the horizontal die surface 26 along and immediately adjacent to the die cavity 16, wherein, when the die assembly 12 and the punch assembly 18 are moved into operable engagement with one another with the sheet metal component 52 therebetween, as shown in FIG. 9, the embossing feature 36 is adapted to form the recessed channel 78 within the top surface 68 of the sheet metal component 52. The embossing feature 36 is adapted to compress the sheet metal component 52 between the embossing feature 36 and the horizontal mandrel surface 30 of the punch assembly 18, thereby reducing a thickness 100 of the sheet metal component 52 to define the recessed channel 78. There is no relief channel within the horizontal mandrel surface 30, thus, as the embossing feature 36 presses downward, the sheet metal component 52 must deform such that the portion of the sheet metal component 52 that defines the recessed channel 78 within the top surface 68 of the sheet metal component 52 has a thickness 100 that is less than the nominal thickness 96 of the sheet metal component 52 and no portion of the bottom surface 72 of the sheet metal component 52 extends below the second plane 74.

Referring again to FIG. 7A, a bottom view of a die 14A corresponding to the circular locating boss 54 shown in FIG. 2 is shown. The horizontal die surface 26A of the die 14A includes a continuous embossing feature 36A extending around the die cavity 16A. Referring to FIG. 7B, a bottom view of a die 14B corresponding to the square locating boss 54 shown in FIG. 6 is shown. The horizontal die surface 26B of the die 14B includes four individual embossing features 36B, each one adapted to form the offset portion 94 adjacent one of the four discontinuous flanges 108 of the locating boss 54.

As shown herein, the offset feature 32 and the embossing feature 36 are substantially similar except for dimensional characteristics. As discussed above, dimensions of the offset feature 32 are dependent upon characteristics of the material of the sheet metal component 52. Likewise, the dimensional characteristics of the embossing feature 36 are similarly dependent upon characteristics of the material of the sheet metal component 52. However, the embossing feature 36 is adapted to apply more force onto the sheet metal component 52, compressing the sheet metal component 52 and reducing a thickness 100 of the portion of the sheet metal component 52 that defines the recessed channel 78. Therefore, for a common press, capable of applying the same pressure when using a die 14 having an offset feature 32 or a die having an embossing feature 36, the embossing feature 36 would likely, in an exemplary embodiment, have dimensional characteristics (width, height) that would focus the force of the apparatus 10 more (ie. smaller width, larger height). Alternatively, the offset feature 32 and the embossing feature are identical, with the only difference being the presence or absence of the relief channel 34 within the horizontal mandrel surface 30, wherein the presence or absence of the relief channel 34 determines if the die offsets the sheet metal component 52 or embosses the sheet metal component 52.

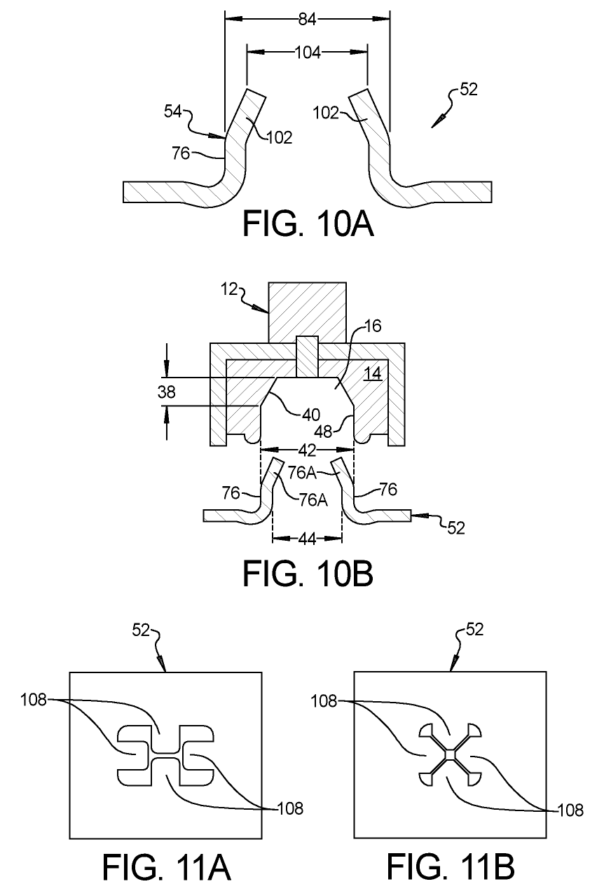

Referring to FIG. 10A, in another exemplary embodiment the outer side wall 76 of the locating boss 54 includes a tapered profile tip 102. The tapered profile tip 102 provides a distal end dimension 104 that is narrower than the outer dimension 86 of the locating boss 54. This makes engagement of the locating boss 54 with the locating opening 60 easier during assembly.

Referring to FIG. 10B, in an exemplary embodiment, the die cavity 16 includes a tapered region 38 adapted to form the tapered profile tip 102 within the locating boss 54. As the side walls 76 of the locating boss 54 move upward within the die cavity 16, eventually, distal ends 76A of the side walls 76 are pushed inward by a sloped surface 40 or surfaces 40 within the die cavity 16.

Referring to FIG. 1A, in an exemplary embodiment, an inner dimension 42 of the die cavity 16 and an outer dimension 44 of the punch 20 define a clearance dimension 46 that is less than a nominal thickness 96 of the sheet metal component 52. For the circular locating boss 54 shown in FIG. 2, the inner dimension 42 of the die cavity 16 would be an inner diameter of a circular die cavity 16, the outer dimension 44 of the punch 20 would be an outer diameter of a cylindrical punch 20, and the clearance dimension 46 would be half of the difference between them. For the square locating boss 54 shown in FIG. 6, the inner dimension 42 of the die cavity 16 and the outer dimension of the punch 20 would each include a dimension along the X-axis and a dimension along the Y-axis, defining the square shape thereof.

As the punch 20 moves upward and deforms the sheet metal component 52, the side walls 76 of the locating boss 54 are pushed upward into the die cavity 16 between the punch 20 and walls 48 of the die cavity 16, wherein the side walls 76 are squeezed and stretched therebetween. This highly compressive process is known as ironing, and reduces the thickness of the side walls 76.

In various embodiments, the locating boss 54 can include a continuous cylindrical or conical (tapered profile tip 102) wall 106, discontinuous flanges 108, or a combination of a continuous wall 106 and discontinuous flanges 108. Referring to FIG. 2, the circular locating boss 54 includes a continuous cylindrical wall portion 106 and a plurality (as shown four) of discontinuous flanges 108 that extend from the continuous cylindrical wall 106. Referring to FIG. 6, a square (and other polygonal shapes) locating boss 54 cannot have a continuous wall, but rather includes a plurality (four for the square shape as shown, five for a pentagon, six for a hexagon, etc.) of discontinuous flanges 108. Each of the plurality of flanges 108 includes a segment of recessed channel 78 extending along and immediately adjacent thereto.

Referring to FIGS. 11A and 11B, in some instances, the sheet metal component 52 may be pre-cut to make formation of the locating boss 54 with the apparatus 10 more efficient. As shown in FIGS. 11A and 11B, the plurality of discontinuous flanges 108 are cut within the flat sheet metal component 52 prior to the sheet metal component 52 being placed within the apparatus 10 wherein the punch pushes the plurality of discontinuous flanges 108 upward to form the locating boss 54. As shown, the pre-cut pattern shown in FIG. 11B corresponds to the four discontinuous flanges 108 and the generally square shaped locating boss 54 shown in FIG. 6.

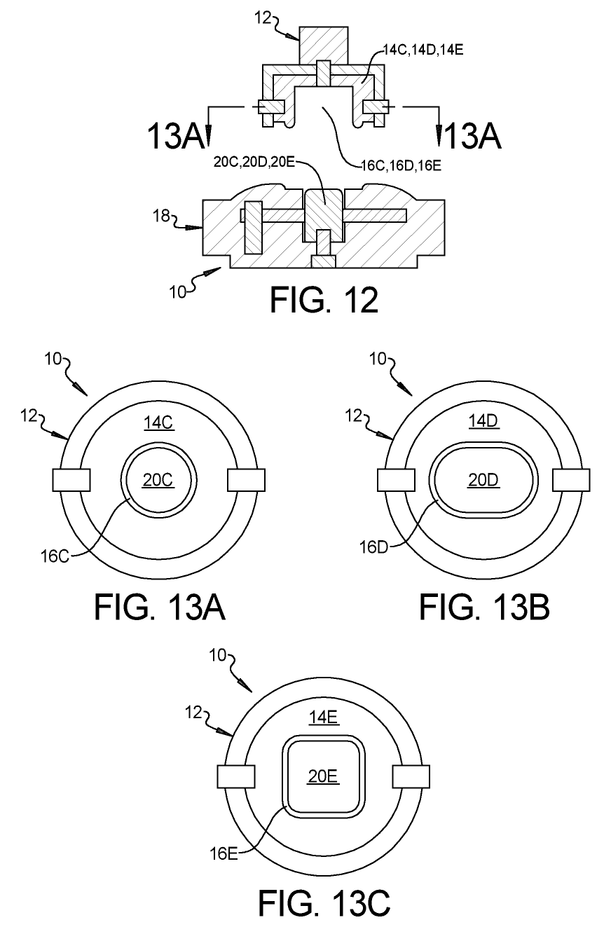

Referring to FIG. 12, the die assembly 12 is adapted to removably support one of a plurality of different modular dies 14C, 14D, 14E having various shapes and sizes. Further, the punch assembly is adapted to removably support one of a plurality of different modular punches 20C, 20D, 20E having various shapes and sizes corresponding to the plurality of modular dies 14C, 14D, 14E. Referring to FIG. 13A, the apparatus is fitted with a first modular die 14C including a die cavity 16C having a circular shape and a first modular punch 20C having a corresponding circular shape. As discussed above, an inner diameter of the die cavity 16C of the first modular die 14C and an outer diameter of the first modular punch 20C will control the amount of ironing that takes place on side walls 76 of a location boss 54 formed with this arrangement. Further, the first modular die 14C may be matched with different circular modular punches having various outer diameters to increase or decrease the amount of ironing experienced by the side walls 76 and the final thickness of the side walls 76.

Referring to FIG. 13B, the apparatus 10 is fitted with a second modular die 14D including a die cavity 16D having an oval shape and a second modular punch 20D having a corresponding oval shape. Dimensions of the die cavity 16D and the second modular punch 20D will control the amount of ironing that takes place on side walls 76 of a location boss 54 formed with this arrangement, and various oval shaped modular dies and punches may be matched to achieve desired ironing and final dimensions. Referring to FIG. 13C, the apparatus 10 is fitted with a third modular die 14E including a die cavity 16E having an square shape and a third modular punch 20E having a corresponding square shape. Dimensions of the die cavity 16E and the third modular punch 20E will control the amount of ironing that takes place on side walls 76 of a location boss 54 formed with this arrangement, and various square shaped modular dies and punches may be matched to achieve desired ironing and final dimensions.

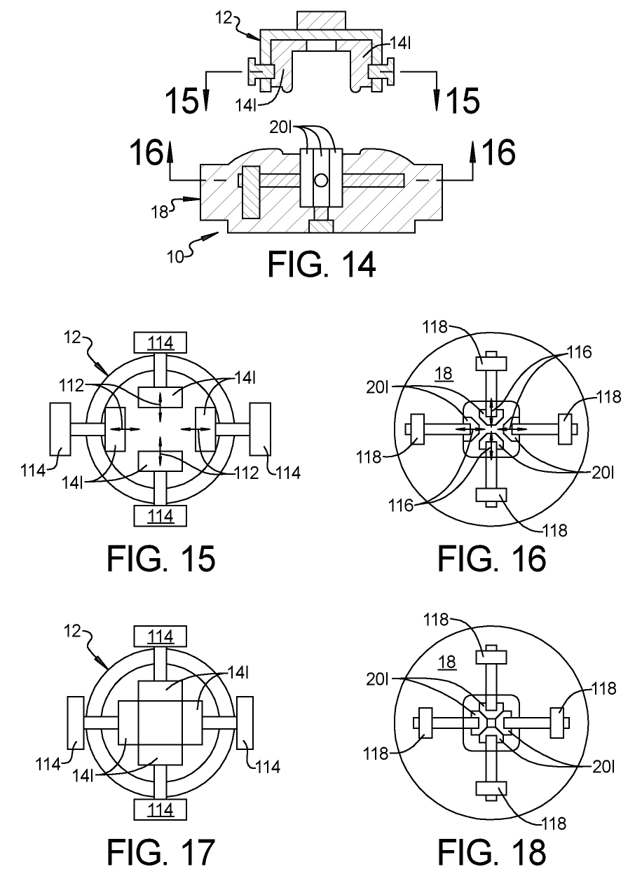

Referring to FIGS. 14, 15, and 16, in an exemplary embodiment, the die 14 includes a plurality of individual die inserts 14I, each die insert 14I being selectively moveable horizontally, wherein the shape and size of the die cavity 16 is selectively adjustable, and, the punch 20 includes a plurality of individual punch inserts 20I, each punch insert 20I being selectively moveable horizontally wherein the shape and size of the punch is selectively adjustable.

Referring to FIG. 15, the die 14 includes four die inserts 14I, each of which is selectively moveable horizontally as shown by arrows 112. Each of the four die inserts 14I is supported on an actuator 114, and can be selectively and individually moved by the actuator 114 using, by way of non-limiting examples, manual, electromechanical, hydraulic, or pneumatic means, by a screw drive, worm drive, linear motor, or geared arrangement or any other suitable technique. As shown, each of the four die inserts 14I are identical, and can be configured to provide multiple square and rectangular die cavity 16 shapes having various dimensions. It should be understood that each of the plurality of die inserts 14I may all be identical, or each of the die inserts 14I may have a unique shape, or any combination of unique and matching shapes.

Referring to FIG. 16, the punch 20 includes four punch inserts 20I, each of which is selectively moveable horizontally as shown by arrows 116. Each of the four punch inserts 20I is supported on an actuator 118, and can be selectively and individually moved by the actuator 118 using, by way of non-limiting examples, manual, electromechanical, hydraulic, or pneumatic means, by a screw drive, worm drive, linear motor, or geared arrangement or any other suitable technique. As shown, each of the four punch inserts 20I are identical, and can be configured to provide multiple square and rectangular punch 20 shapes having various dimensions. It should be understood that each of the plurality of punch inserts 20I may all be identical, or each of the punch inserts 20I may have a unique shape, or any combination of unique and matching shapes.

By way of example, the die inserts 14I and punch inserts 20I can be selectively and individually moved to positions as shown in FIGS. 15 and 16 to provide a rectangular shaped locating boss 54, using a sheet metal component having a pre-cut pattern such as shown in FIG. 11A. Alternatively, the same die inserts 14I and punch inserts 20I can be selectively moved to different positions, as shown in FIGS. 17 and 18 to provide a square shaped locating boss 54, using a sheet metal component having a pre-cut pattern defining a plurality of discontinuous flanges 108 such as shown in FIG. 11B, wherein the resulting locating boss 54 corresponds to the generally square shaped locating boss 54 shown in FIG. 6. The selectively moveable die inserts 14I and the selectively moveable punch inserts 20I provide for dimensional adjustability between the ultimate shape/size of the die cavity 16 and the ultimate shape/size of the punch 20 to allow ironing of the side walls 76 to be fine tuned to specific parameters and a precise final thickness of the side walls 76.

An apparatus 10 of the present disclosure offers the advantage of providing for the formation of a locating boss 54 which allows a secondary component 56 to be placed onto a sheet metal component 52 with precise locating of the secondary component 56 relative to the primary component 52, wherein a fillet radius 80 of the locating boss 54 is positioned below a first plane 70 defined by a top surface 68 of the sheet metal component 52, and thus, does not interfere with the secondary component 56 being positioned in direct contact with the top surface 68 of the primary component 52. Prior art solutions to interference by the fillet radius of the locating boss include increasing the inner dimension of the corresponding locating opening in the secondary component, however, this reduces the ability to precisely position the secondary component relative to the primary component. The novel features of the present disclosure allow formation of a locating boss 54 that provides precise positioning without interference from the fillet radius. Further, embodiments of the apparatus 10 of the present disclosure allow the geometry (dimensions, shapes), material thickness and ironing of side walls of the locating boss 54 to be selectively and precisely controlled to provide a locating boss 54 made to order for specific applications.

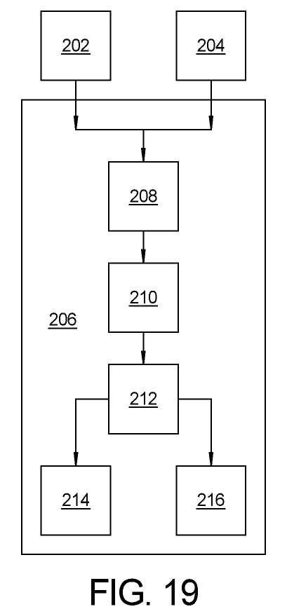

Referring to FIG. 19, a method 200 of forming a locating boss 54 within a sheet metal component 52, includes, beginning at block 202, supporting a die 14 having a horizontal die surface 26 and a die cavity 16 formed therein within a die assembly 12, moving to block 204, moveably supporting a punch 20 within a punch assembly 18 that includes a mandrel 28 extending around the punch 20 and defines a horizontal mandrel surface30, and moving to block 206, moving the punch assembly 18 and the die assembly 12 into operable engagement with one another and forming a locating boss 54 within the sheet metal component 52.

The moving the punch assembly 18 and the die assembly 12 into operable engagement with one another and forming a locating boss 54 within the sheet metal component 52 at block 206 including, moving to block 208, engaging, with the horizontal die surface 26 of the die assembly 12, a top surface 68 of the sheet metal component 52 that defines a first plane 70, and engaging, with the horizontal mandrel surface 30 of the punch assembly 18, a bottom surface 72 of the sheet metal component 52 that defines a second plane, and securing the sheet metal component therebetween, moving to block 210, moving the punch 20, relative to the mandrel 28, upward into the die cavity 16, moving to block 212, forming, with a tapered region 38 of the die cavity 16, a tapered profile tip 102 within the locating boss 54.

In an exemplary embodiment, the moving the punch assembly 18 and the die assembly 12 into operable engagement with one another and forming a locating boss 54 within the sheet metal component 52 at block 206 further includes, moving from block 212 to block 214, when the die assembly 12 and the punch assembly 18 are moved into operable engagement with one another with the sheet metal component 52 therebetween, forming, with an offset feature 32 extending from the horizontal die surface 26 along and immediately adjacent to the die cavity 16, an offset portion 94 within the sheet metal component 52 extending along and immediately adjacent to the locating boss 54, extending below the second plane 74, and defining a recessed channel 78 within the top surface 68 of the sheet metal component 52, wherein a fillet radius 80 of the locating boss 54 is positioned below the first plane 70, and a relief channel 34 formed within the horizontal mandrel surface 30 is adapted to allow formation of the offset portion 94 within the sheet metal component 52 without reducing a thickness 96 of the sheet metal component 52, such that a nominal thickness 96 of the sheet metal component 52 and a thickness 98 of the offset portion 94 of the sheet metal component 52 are uniform.

In another exemplary embodiment, the moving the punch assembly 18 and the die assembly 12 into operable engagement with one another and forming a locating boss 54 within the sheet metal component 52 at block 206 further includes, moving from block 212 to block 216, when the die assembly 12 and the punch assembly 18 are moved into operable engagement with one another with the sheet metal component 52 therebetween, forming, with an embossing feature 36 extending from the horizontal die surface 26 along and immediately adjacent to the die cavity 16, a recessed channel 78 within the top surface 68 of the sheet metal component 52, including, compressing, with the embossing feature 36, the sheet metal component 52 between the embossing feature 36 and the horizontal mandrel surface 30 of the punch assembly 18, and reducing a thickness of the sheet metal component 52 to define the recessed channel 78, wherein a portion of the sheet metal component 52 that defines the recessed channel 78 within the top surface 68 of the sheet metal component 52 has a thickness 100 that is less than a nominal thickness 96 of the sheet metal component 52, and no portion of the bottom surface 72 of the sheet metal component 52 extends below the second plane 74.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An apparatus for forming a locating boss within a sheet metal component, comprising:
a die assembly adapted to support a die having a die cavity formed therein; and
a punch assembly having a punch moveably supported therein; and
wherein:
the die assembly and the punch assembly are operably positioned relative to one another and moveable relative to one another to bring the die assembly into operable engagement with the punch assembly with a sheet metal component positioned therebetween;
the punch of the punch assembly adapted to extend into the die cavity to form a locating boss within the sheet metal component;
the sheet metal component having a top surface that defines a first plane and a bottom surface that defines a second plane, the locating boss extending upward from the top surface; and
the die including features adapted to form a recessed channel within the top surface of the sheet metal component and extending along and immediately adjacent to the locating boss such that a fillet radius of the locating boss is positioned below the first plane.

2. The apparatus of claim 1, wherein:
the die includes a horizontal die surface and the punch assembly includes a mandrel extending around the punch and defining a horizontal mandrel surface; and
wherein, when the die assembly and the punch assembly are moved into operable engagement with one another with a sheet metal component therebetween:
the horizontal die surface engages the top surface of the sheet metal component and the horizontal mandrel surface engages the bottom surface of the sheet metal component to secure the sheet metal component therebetween; and
the punch is vertically moveable relative to the mandrel and is adapted to move upward into the die cavity, thereby forming the locating boss.

3. The apparatus of claim 2, wherein the die includes an offset feature extending from the horizontal die surface along and immediately adjacent to the die cavity, wherein, when the die assembly and the punch assembly are moved into operable engagement with one another with the sheet metal component therebetween, the offset feature is adapted to form an offset portion within the sheet metal component extending along and immediately adjacent to the locating boss and extending below the second plane, the offset portion defining the recessed channel within the top surface of the sheet metal component.

4. The apparatus of claim 3, wherein the horizontal mandrel surface of the punch assembly includes a relief channel formed therein, the relief channel adapted to allow formation of the offset portion within the sheet metal component without reducing a thickness of the sheet metal component, such that a nominal thickness of the sheet metal component and a thickness of the offset portion of the sheet metal component are uniform.

5. The apparatus of claim 2, wherein the die includes an embossing feature extending from the horizontal die surface along and immediately adjacent to the die cavity, wherein, when the die assembly and the punch assembly are moved into operable engagement with one another with the sheet metal component therebetween, the embossing feature is adapted to form the recessed channel within the top surface of the sheet metal component.

6. The apparatus of claim 5, wherein the embossing feature is adapted to:
compress the sheet metal component between the embossing feature and the horizontal mandrel surface of the punch assembly; and
reduce a thickness of the sheet metal component to define the recessed channel, wherein:
a portion of the sheet metal component that defines the recessed channel within the top surface of the sheet metal component has a thickness that is less than a nominal thickness of the sheet metal component; and
no portion of the bottom surface of the sheet metal component extends below the second plane.

7. The apparatus of claim 2, wherein the die cavity includes a tapered region adapted to form a tapered profile tip within the locating boss.

8. The apparatus of claim 2, wherein an inner dimension of the die cavity and an outer dimension of the punch define a clearance dimension that is less than a nominal thickness of the sheet metal component.

9. The apparatus of claim 8, wherein, when the die assembly and the punch assembly are moved into operable engagement with one another with the sheet metal component therebetween and the punch is vertically moved upward into the die cavity, the die cavity and the punch are adapted to iron side walls of the resulting locating boss.

10. The apparatus of claim 2, wherein the apparatus is adapted to form a locating boss including one of:
one of a continuous cylindrical or conical wall;
discontinuous flanges; or
a combination of a continuous wall and discontinuous flanges.

11. The apparatus of claim 2, wherein:
the die assembly is adapted to support one of a plurality of different dies having die cavities of varying shapes and sizes; and
the punch assembly is adapted to support one of a plurality of different punches having shapes and sizes corresponding to the plurality of dies.

12. The apparatus of claim 2, wherein:
the die includes a plurality of individual die inserts, each die insert being selectively moveable horizontally wherein the shape and size of the die cavity is selectively adjustable; and
the punch includes a plurality of individual punch inserts, each punch insert being selectively moveable horizontally wherein the shape and size of the punch is selectively adjustable.

13. An apparatus for forming a locating boss within a sheet metal component of a rechargeable energy storage system (RESS), comprising:
a die assembly adapted to support a die having a horizontal die surface and a die cavity formed therein; and
a punch assembly having a punch moveably supported therein and a mandrel extending around the punch and defining a horizontal mandrel surface; and
wherein:
the die assembly and the punch assembly are operably positioned relative to one another and moveable relative to one another to bring the die assembly into operable engagement with the punch assembly with the sheet metal component positioned therebetween, wherein the sheet metal component has a top surface that defines a first plane and a bottom surface that defines a second plane, the locating boss extending upward from the top surface, the horizontal die surface adapted to engage the top surface of the primary component and the horizontal mandrel surface adapted to engage the bottom surface of the sheet metal component to secure the sheet metal component therebetween;
the punch is vertically moveable relative to the mandrel and is adapted to move upward into the die cavity, thereby forming the locating boss; and
the die including features adapted to form a recessed channel within the top surface of the sheet metal component and extending along and immediately adjacent to the locating boss such that a fillet radius of the locating boss is positioned below the first plane.

14. The apparatus of claim 13, wherein:
the die includes an offset feature extending from the horizontal die surface along and immediately adjacent to the die cavity and the horizontal mandrel surface of the punch assembly includes a relief channel formed therein;
wherein, when the die assembly and the punch assembly are moved into operable engagement with one another with the sheet metal component therebetween, the offset feature is adapted to form an offset portion within the sheet metal component extending along and immediately adjacent to the locating boss and extending below the second plane, the offset portion defining the recessed channel within the top surface of the sheet metal component and the relief channel adapted to allow formation of the offset portion within the sheet metal component without reducing a thickness of the sheet metal component, such that a nominal thickness of the sheet metal component and a thickness of the offset portion of the sheet metal component are uniform.

15. The apparatus of claim 13, wherein the die includes an embossing feature extending from the horizontal die surface along and immediately adjacent to the die opening, wherein, when the die assembly and the punch assembly are moved into operable engagement with one another with the sheet metal component therebetween, the embossing feature is adapted to:
compress the sheet metal component between the embossing feature and the horizontal mandrel surface of the punch assembly; and
reduce a thickness of the sheet metal component to define the recessed channel, wherein:
a portion of the sheet metal component that defines the recessed channel within the top surface of the sheet metal component has a thickness that is less than a nominal thickness of the sheet metal component; and
no portion of the bottom surface of the sheet metal component extends below the second plane.

16. The apparatus of claim 13, wherein the die cavity includes a tapered region adapted to form a tapered profile tip within the locating boss.

17. The apparatus of claim 13, wherein an inner dimension of the die cavity and an outer dimension of the punch define a clearance dimension that is less than a nominal thickness of the sheet metal component, wherein, when the die assembly and the punch assembly are moved into operable engagement with one another with the sheet metal component therebetween and the punch is vertically moved upward into the die cavity, the die cavity and the punch are adapted to iron side walls of the resulting locating boss.

18. The apparatus of claim 13, wherein:
the die assembly is adapted to support one of a plurality of different modular dies, each of the plurality of different modular dies having a unique shape and size; and
the punch assembly is adapted to support one of a plurality of different modular punches, each of the plurality of modular punches having a unique shape and size.

19. The apparatus of claim 13, wherein:
the die includes a plurality of individual die inserts, each die insert being selectively moveable horizontally wherein the shape and size of the die cavity is selectively adjustable; and
the punch includes a plurality of individual punch inserts, each punch insert being selectively moveable horizontally wherein the shape and size of the punch is selectively adjustable.

20. A method of forming a locating boss within a sheet metal component, comprising:
supporting a die having a horizontal die surface and a die cavity formed therein within a die assembly;
moveably supporting a punch within a punch assembly that includes a mandrel extending around the punch and defines a horizontal mandrel surface;
moving the punch assembly and the die assembly into operable engagement with one another and forming a locating boss within the sheet metal component , including:
engaging, with the horizontal die surface of the die assembly, a top surface of the sheet metal component that defines a first plane, and engaging, with the horizontal mandrel surface of the punch assembly, a bottom surface of the sheet metal component that defines a second plane, and securing the sheet metal component therebetween;
moving the punch, relative to the mandrel, upward into the die cavity;
forming, with a tapered region of the die cavity, a tapered profile tip within the locating boss; and
one of:
when the die assembly and the punch assembly are moved into operable engagement with one another with the sheet metal component therebetween, forming, with an offset feature extending from the horizontal die surface along and immediately adjacent to the die cavity, an offset portion within the sheet metal component extending along and immediately adjacent to the locating boss, extending below the second plane, and defining a recessed channel within the top surface of the sheet metal component, wherein:
a fillet radius of the locating boss is positioned below the first plane; and
a relief channel formed within the horizontal mandrel surface is adapted to allow formation of the offset portion within the sheet metal component without reducing a thickness of the sheet metal component, such that a nominal thickness of the sheet metal component and a thickness of the offset portion of the sheet metal component are uniform; or
when the die assembly and the punch assembly are moved into operable engagement with one another with the sheet metal component therebetween, forming, with an embossing feature extending from the horizontal die surface along and immediately adjacent to the die cavity, a recessed channel within the top surface of the sheet metal component, including:
compressing, with the embossing feature, the sheet metal component between the embossing feature and the horizontal mandrel surface of the punch assembly; and
reducing a thickness of the sheet metal component to define the recessed channel, wherein:
a portion of the sheet metal component that defines the recessed channel within the top surface of the sheet metal component has a thickness that is less than a nominal thickness of the sheet metal component; and
no portion of the bottom surface of the sheet metal component extends below the second plane.
